(19) United States
(12) Patent Application Publication
(10) Pub. No.: US 2016/0124101 A1
(43) Pub. Date: May 5, 2016

(54) Method and Apparatus For Interactive 3D Visual Display of Microseismic Events

(71) Applicant: SIGMA Cubed Inc., Houston, TX (US)

(72) Inventors: Sean Spicer, Houston, TX (US); Marc Hildebrand, Houston, TX (US); Chris Deeb, Marietta, GA (US)

(73) Assignee: SIGMA Cubed Inc., Houston, TX (US)

(21) Appl. No.: 14/708,263

(22) Filed: May 10, 2015

Related U.S. Application Data
(60) Provisional application No. 14/120,440, filed on Mar. 30, 2015.
(60) Provisional application No. 61/937,757, filed on Feb. 10, 2014.

(51) Int. Cl. G01V 1/34; G01V 1/133

(52) U.S. Cl. CPC G01V 1/345; G01V 1/133; G01V 2210/74

(57) ABSTRACT

The disclosure teaches an interactive 3 dimensional microseismic event color visual display method comprising the steps of displaying an interactive 3D visual image of 3 dimensional data of microseismic event data occurring from geologic stimulation and manipulating the visual display by changing a blend mode of microseismic event data among alpha blending, additive blending, and opacity by factors comprising color, size, event location, and translucency wherein such factors correlate to amplitude, location, depth, probability, direction, time, distance from wellbore and combinations thereof.

### RELATED APPLICATIONS

This application claims the benefit of provisional application No. 61/937,757 filed Feb. 10, 2014 and No. 62/139,936 entitled “Method and Apparatus for Interactive 3D Visual Display of Microseismic Events” filed Mar. 30, 2015. These applications is incorporated herein in its entirety.

### BACKGROUND

1. Field of Use

This disclosure pertains to a highly interactive method of display of detailed, voluminous geophysical data in readily comprehensible format and a system for the display of such information.

2. Prior Art

Prior art has included 2D and 3D displays; charts, graphs, and spread sheet presentations of geologic data. 3D data presentation has been limited to 2D projection (typically using Microsoft Excel Charts) or 3D rendering wherein all the data points are solid, thereby obscuring inner layers of data.

### SUMMARY OF DISCLOSURE

This invention relates to geophysical data processing and graphical user interfaces, and in particular to systems and methods providing visualization and presentation (maneuverable or rotational display) of 3-D microseismic geophysical data in a highly interactive format. The disclosure allows the user to manipulate the data for enhanced 3D visual display in real time using interactive tools. The data manipulation taught by this disclosure allows for ready or expedited understanding of the data and the geologic properties of the subject site.

The disclosure teaches the use of multilayered imagery and utilizes the techniques of 3D color blending. This includes changing the alpha and color-blending mathematics of the 3D computer generated image. When using alpha blending, the image or symbol of each event data point is translucent. The background events are therefore not completely obscured. In color blending, the symbols of event data may be of varied colors. Color-blending combined the colors into a third color.

Computer-intensive processing of microseismic data is the main tool for imaging the Earth's subsurface to monitor areas of hydraulic fracturing stimulation in hydrocarbon reservoirs and estimate rock and fluid properties. Microseismic data is recorded at the earth's surface or in wells, and an accurate model of the underlying hydraulic fracture structure is constructed by processing the data. The reconstruction of accurate 3-D microseismic events requires the handling of a huge amount of microseismic data and the application of computer-intensive detection and location algorithms. The volume of data can be in terabytes requiring the use of large scale parallel computers. The recording, processing, and analysis of microseismic data shares similar characteristics to that of conventional 2D and 3D seismic data.

Along with this volume of input data is a resulting large volume of output data. Stated differently, this method produces a very large quantity of data. This data is currently communicated in lengthy reports containing multitudes of graphs. The review and assimilation of this volume of data requires time and is subject to individual interpretation. The economic consequences of misinterpretation are large. The economic costs resulting from creation of unnecessary boreholes, casing and well development cannot be overstated.

An advantage of the Applicant's disclosure is that the data required to provide the 3D manipulative display is greatly reduced. The disclosure can utilize data processed from an event catalog prepared by the Applicant's system utilizing data calculated from the geophones, etc. In some embodiments, there may be one or more data or signal processing step before the signals are manipulated and correlated into an event catalog. The Applicant's system begins with the massive amount of data generated by at least one (typically at least 3) geophone arrays recording signals from one or more microseismic events often occurring in rapid succession, e.g., 5-10 events per second.

The data is received from the event catalog to a CPU. The CPU includes a RAM component. The apparatus also contains a GPU. The GPU also contains a memory component. This may be video RAM or DRAM (display memory). The CPU, GPU and Ram may interface with a bus. In one embodiment, the GPU is connected to the CPU via a bridge. The GPU is programmable. The program of the GPU is based upon parameters of the CPU. As will be discussed below, there may be multiple parameters.

The Applicant has developed interactive techniques to apply to the presentation of complex and voluminous 3-D images of microseismic event data. This technique involves blending, particularly the blending of pixels on a display screen. (It will be appreciated that handling the overlap of colors may utilize the technique of compositing. In compositing, a pixel's value in the composite image is taken from the background image unless the foreground image has a nontransparent value, in which case the value is taken from the foreground image. In contrast, in a blending of two images the resulting pixel value is a linear combination of the values of the two component pixels.)

In one application, these blending techniques readily clarify and distinguish microseismic observation results, e.g., results of fracturing of geologic formations inducing microseismic events. The Applicant is applying the techniques of computerized blending of color and light intensity, commonly described as alpha- and color-blending (referred to herein as “blend mode”). Blending can create a data set [RGBA] where A is alpha. Also variable coloring and sizing of data symbols and selective presentation of data is disclosed. Using these enhanced graphic presentation techniques, the user is able to manipulate the visual display of microseismic event data by factors comprising micro seism amplitude, location, depth, probability, direction, time, distance from wellbore and combinations thereof. This manipulation can be performed in real time, thereby tailoring the visual aide to emphasize the characteristics of the property of interest.

### SUMMARY OF DRAWINGS

The patent or application file contains at least one drawing executed in color. Copies of this patent or patent application publication with color drawings will be provided by the Office upon request and payment of the necessary fee.

The accompanying drawings, which are incorporated in and constitute a part of the specification, illustrate preferred embodiments of the disclosure. These drawings, together with the general description of the disclosure given above and the detailed description of the preferred embodiments given below, serve to explain the principles of the disclosure.

FIG. 1 illustrates a screen shot of the user interface control display. The display responds to user controlled track ball or mouse. It can also be used with a touch screen display. Also illustrated is a side angled display perspective view looking across the geologic formation. The wellbore 100 is illustrated in the color green and traversing right to left. The microseismic events are illustrated by spherical symbols. The symbols are depicted in the opaque mode. Illustrated are 3D display perspective representations of each microseismic event. The color of the symbols are determined by the amplitude of the event signal. The larger the microseismic event, the larger the amplitude of the signal.

FIG. 2 illustrates the same data depicted in FIG. 1 but with the alpha blending activated.

FIG. 3 illustrates a different 3D display perspective representation of microseismic events dispersed around the borehole wherein the size of each microseismic event symbol can represent the amplitude of the event. The “Dot Style” has been changed to Focus and the “Size” control has been adjusted. The color of each microseismic event can be correlated to a stage of a geologic stimulation event.

FIG. 4 illustrates a 3D perspective representation of microseismic events in a geologic formation. The perspective is the same as that depicted in FIG. 3. The events are depicted by amplitude by varying the size of the symbols. The blend mode is opaque causing all the events to be shown.

FIG. 5 illustrates a top view of the event looking down into the geologic formation. The visual display is set in additive mode causing the areas of greatest intensity to be shown lighter. As discussed in greater detail herein, the additive mode combines the colors of multiple pixels thereby lightening the image. The light spots show areas where there are multiple events. The “Dot Style” control has been adjusted to “hotspot”.

FIG. 6 illustrates another top view of the event looking down into the geologic formation. The illustrated perspective is identical to FIG. 5. The alpha phase has been activated. As discussed in greater detail herein, the alpha stage multiplies the difference of multiple pixels in accordance with the discussed formula. The effect is to darken the areas where there are multiple events.

FIG. 7 illustrates another top view identical to FIGS. 5 and 6. The settings are set to opaque.

FIG. 8 illustrates a logic flow diagram showing the functional steps of opaque, alpha and additive blending of microseismic event symbols.

FIG. 9 is outline of the major components of the system subject of the disclosure showing the relationship of the data input in to the CPU, the RAM, the bridge and GPU and VRAM.

FIG. 10 illustrates the overlap of two separate objects wherein the area of the overlap is blended. In the preferred embodiment of the invention it will be clear which object is in front of the other.

FIG. 11 illustrates an event catalog. It will be appreciated that the variable or parameters posted on the X axis are nearly unlimited depending upon the requirements of the operator. In many embodiments, the creation of the event catalog is part of the step immediately preceding the data being received by the CPU.

### DETAILED DESCRIPTION OF DISCLOSURE

The subject matter of the present disclosure is described with reference to certain preferred embodiments. It is not intended, however, to limit the scope of the disclosure. The claimed subject matter thus, might also be embodied in other ways to include different steps, or combinations of steps, similar to the ones described herein and other technologies. Although the term “step” may be used herein to describe different elements of methods employed, the term should not be interpreted as implying any particular order among or between various steps herein disclosed unless otherwise expressly limited by the description to a particular order.

This disclosure teaches the use of multilayered imagery and utilizes the techniques of 3D blending to clearly and quickly display voluminous amounts of 3D microseismic data. Blending includes the techniques of alpha- and color-blending.

Modern geophysicists and geologists must pour through literally reams of data in evaluating potential drilling sites. Still additional information must be collected and assimilated in order make determinations of which section of a wellbore is likely to be productive in the production of hydrocarbons. Depiction of the geologic data utilizing 2D computer models is currently utilized.

This disclosure pertains to the evaluation of wellbore data after geologic stimulation. Specifically, the disclosure pertains to interactive 3D displays of microseismic data. As is known, geologic stimulation, commonly known as hydraulic fracturing (hereinafter “hydraulic fracturing”), pertains to the practice of pumping water and other additives under great pressure into a wellbore. The high pressure fractures the geologic formation surrounding the wellbore. The fracturing of the geologic formation creates mini earthquakes or microseisms referred to as microseismic events, (hereinafter “microseismic”). These events are detected by one or more geophones.

Typically, a wellbore is hydraulically stimulated multiple times (stages) along the length of the wellbore. These can be separate hydraulic fracturing events. There may be in excess of 50 stages. The multiple microsceismic events can occur in rapid succession, e.g., at a frequency of 5-10 per second. The geophones can be positioned in separate nearby wellbores. Typically, the geophones comprise a set of between 40-120, 3-component phones spaced vertically in a monitoring well. There may be multiple monitoring wells.

The microseismic events produced by the multiple episodes of hydraulic fracturing trigger sounds that can be detected by the geophones. The signals observed by the geophones in response to the events are recorded. The signals can also be transmitted after processing (including use of a filter in one embodiment). In one embodiment, the signals will be transmitted through several stages, including the step where the event catalog is generated. The signals can then be transmitted to a central processing unit (CPU) of the system subject of the disclosure. In another embodiment, the signals may be transmitted directly to the CPU.

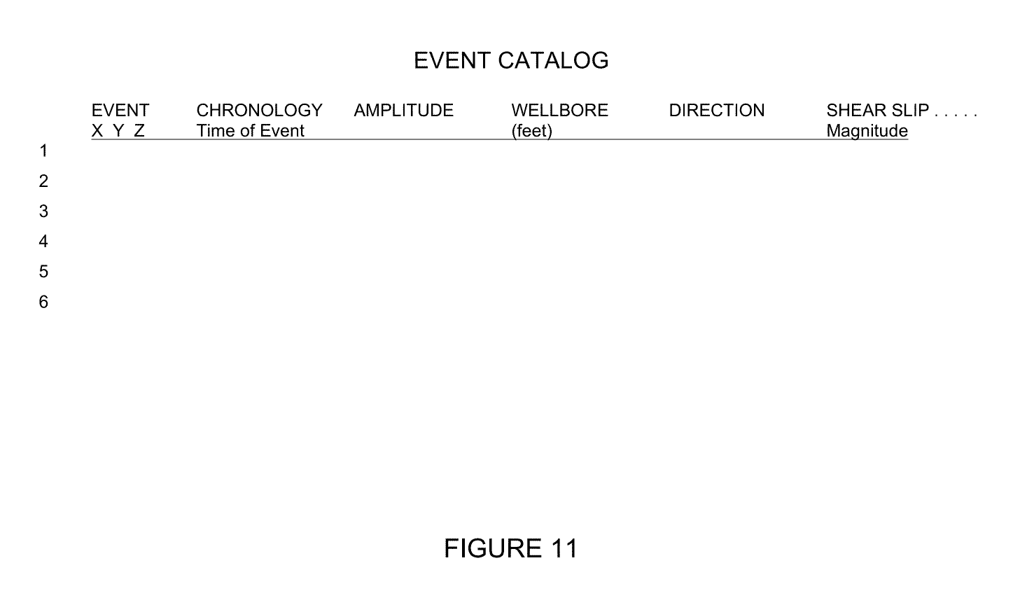

The compilation of signals from multiple hydraulic fracturing events in a typical well bore may exceed 6,000. It will be appreciated that each of the 6,000 events will have separate geophone signals for each geophone deployed. The separate signals must be calculated into separate X, Y and Z coordinates, chronological time of event, amplitudes and direction for each event. This data is separately processed into machine readable data. There can be innumerable data elements that are recording from a hydraulic fracturing event. This recording and correlation of data by hydraulic fracturing event is hereinafter termed an “event catalog.” See FIG. 11 and the discussion infra. In the preferred embodiment the event catalog is compiled before the data is transferred to the CPU as an integral part of the data blending disclosure.

In one embodiment, upon the occurrence of a microseismic event, the computer program directs the recording of data to “look back” one second and look forward “one second”. This provides a window for evaluating the circumstance surround the event. Obviously the time periods may be

The processing of the large volume of data recorded from a hydraulic fracturing event may require parallel processing (that may constitute utilizing multiple computer configured in parallel each processing a segment of data). The output of this process may be an event catalog. See FIG. 11. The event catalog may be saved in a .csv format. The catalog may contain the FFID (fracturing event) M (event magnitude), SNR (signal to noise ratio) and other variables.

The creation of the event catalog may include the processor to identify and discard certain data. This may include, for example, discarding extraneous data not consistently reported by the plurality of geophone, the location not consistently reported by the several geophones or data not measuring a preset signal level.

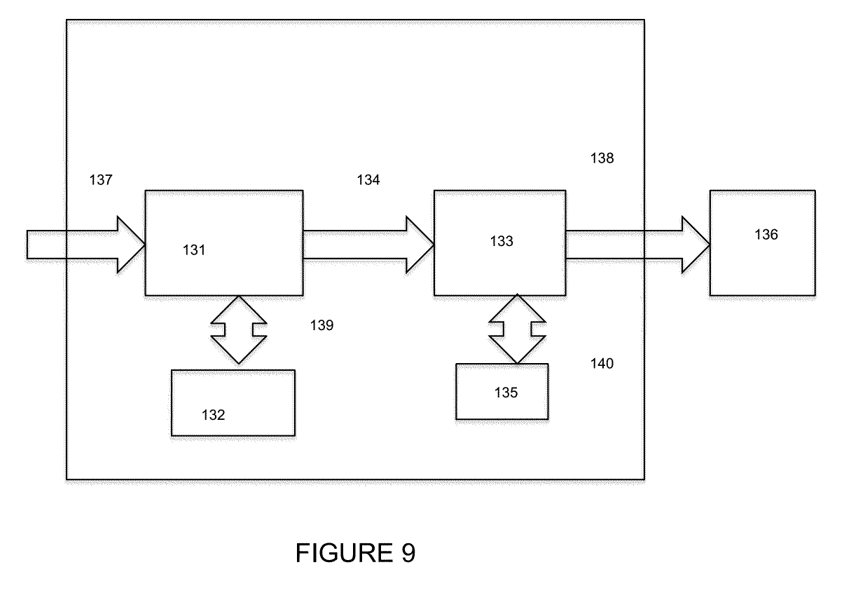

The data is integrated and correlated in the creation of the event catalog. The event catalog can be programmed to select only certain data of certain variables to be inputted into the CPU illustrated in FIG. 9. This can significantly reduce the data to be processed by the CPU. Quantity of data inputted that temporarily exceeds the processing capacity of the CPU may be temporarily stored in the RAM.

It will be appreciated that in one embodiment, each microseismic event can be recorded in the event catalog.

In this disclosure, the reading function (processing) may be performed by a computer processing unit (CPU) that is a component of the computing system in communication with the GPU.

FIG. 9 is a basic illustration of the system subject of the disclosure. Data is imputed as illustrated by arrow 137. The source of this input can be a computer readable disk, a satellite feed, or another computer. The data is imputed into a CPU 131 configured to handle the influx of microseismic event data Platform not important The CPU is supplemented by a Random Access Memory component. The memory component is in communication with the CPU by communication or data carrying wires or cable 139. The data processed by the CPU flows to a Graphics Processing Unit (GPU) 138 utilizing a bridge 134. The GPU is supplemented by a memory unit 135 such as a VRAM. The VRAM is in communication with the GPU by communication or data carrying wires 140.

The GPU, having processed and blended the data and processed the graphic representations of the data to be maneuverable and rotatable is transmitted via a data connection to a display 136. The display includes components such a key board, mouse and counsel including controls for enlarging or expanding the image, rotating the imaging, changing the blending mode of the displayed data, etc.

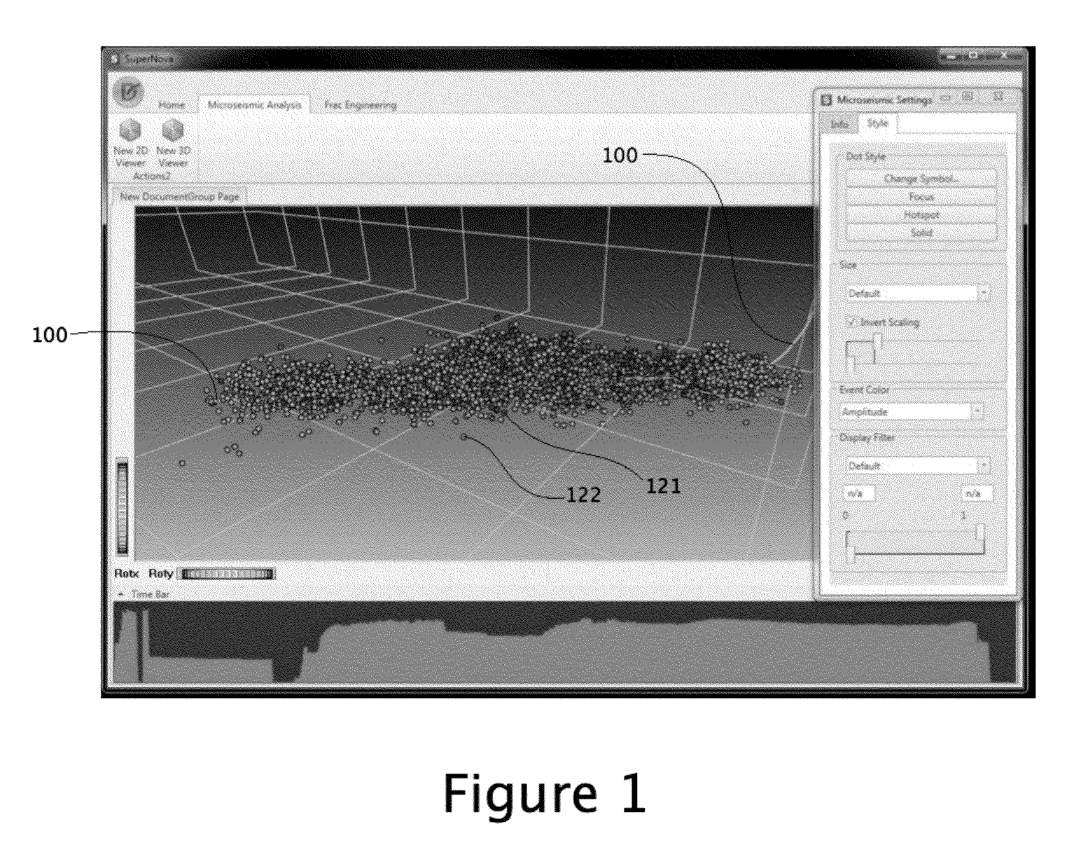

The controls are, in the embodiment illustrated in FIGS. 1 through 7 are style, dot style, (including change symbol, focus, hotspot, solid), size (amplitude (as a pull down menu), invert scaling), event color (amplitude as a pull down menu), and display filter (including default as a pull down menu and a scaling control). It will be appreciated that other control configurations can be utilized and still be within the scope of this disclosure.

The GPU is adapted to allow display of the data in the alpha blend mode, additive blend mode or opacity mode. It will be appreciated that there are 12 possible ways of coloring a pixel in a display.

It will be appreciated that the recorded time of a microseismic event at the wellbore can be important. For example events closer to the wellbore may occur after events are recorded more distant from the wellbore. It will be appreciated that the wellbore is the location of the geologic stimulation event or hydraulic fracturing (creating the microseismic events).

One unique element to this disclosure includes but is not limited to the use of a modified graphics library overlaying menu/interface software to present microseismic event data in a very easily understood visual presentation. The 3D presentation with 360 degree rotation and color blending allows observation/evaluation of microseismic events that could not be previously evaluated.

The modified graphics library utilizes an application programming interface (API) for three-dimensional computer graphics. The functions performed by modified graphics library may include, for example, geometric and raster primitives, RGBA or color index mode, display list or immediate mode, viewing and modeling transformations, lighting and shading, hidden surface removal, alpha blending (translucency), anti-aliasing, texture mapping, atmospheric effects (fog, smoke, haze), feedback and selection, stencil planes and accumulation buffer.

The RGB sequence is the value assigned to create the color of the events shown on the display. It will be appreciated that the RGB signifies the primary colors red, green and blue. One or more of these variables may be substituted for microseismic data. This may result in all the events displayed as one color. However the placement and size of each displayed event may furnish very important data that is easily comprehended. It will be appreciated that the display may be rotated 360 degrees to further explain the data from each microseismic event. It will be further appreciated that the correlation of the multiple variables that comprise the event catalog combined with the CPU and RAM and the separate GPU and VRAM facilitate the processing of data for display in real time.

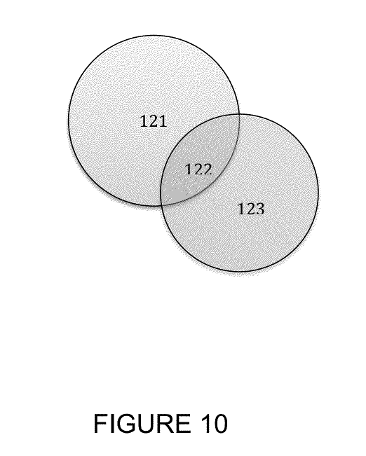

In the RGBA sequence, the A or alpha variable signifies the alpha value assigned by the CPU. (It will be appreciated that the CPU processes the data to the RGBA sequence.) The alpha value encodes the coverage of each pixel. This collection of values can be referred to as the alpha channel. In one embodiment, the alpha value is the alpha blending value. This can be controlled at the display. The alpha blending results in a translucent display of each microseismic event. The alpha value can be utilized when the area of two separate events may overlap. (See FIG. 10) Overlayment of multiple microseismic events will remain visible. The order of the display of multiple over laying microseismic events can be reversed by rotating the display 180 degrees. This switching of positions, background displayed prominently behind the more proximate microseismic events can be accomplished by adjusting the controls of the display module. Either technique will result in a clear display of each event. The relationship or proximity of each event will become clearly visible. It will be appreciated that each event may be assigned a differing volume based upon selected variables such as the event magnitude, proximity to the well bore, etc.

For a transparent image or pixel, the variable set would be [R, G, B, 0, ] For the color green, the variable set would be [0, 1.0, 0, A] If the color green overlays the color blue, the variable set is [0, A, B, A] and F_{A}=1 and F_{B}=1−α_{A}. If each event is displayed as opaque, the event behind the front event would be obscured.

To avoid this, the following is an example of the novel use alpha blending for the study and display of multiple microseismic events. These events are created by hydraulic fracturing. Alpha blending is performed by the GPU. The alpha value is assigned a value of less than 1. This applies when the representative shape of an event is superimposed over the representative shape of an underlying event. It is desired that the underlying event remain visible. This is further discussed in paragraph [0051] infra.

For example:

| | R | G | B | A |
|---|---|---|---|---|
| Back event (black): “old pixel” | 0 | 0 | 0 | .3 |
| Front event (red) “new pixel” | 1 | 0 | 0 | .3 |

Final pixel: (.3 (1 − 0) + 0; .3(0 − 0) + 0; .3(0 + 0) + 0)

It will be appreciated that the alpha value is a blend of the two events, i.e., alpha blending discussed below. (It may be a blending of more than two events.) Both are visible on the display in the area of the overlap. The display will show a red sphere (or other selected shape or symbol). The sphere will be translucent since the alpha value of each sphere is less than 1, i.e., 0.3. At the overlap, the area of the overlap will be a darker red as the alpha value is now 0.6. The CPU may transmit the data to the GPU via .GSLS.

Briefly, additive blending does not utilize an alpha value.

For example:

| | R | G | B |
|---|---|---|---|
| Back event “old pixel” | 0 | 0 | 0 |
| Front event “new pixel” | 1 | 0 | 0 |

Final Pixel = (0 + 1) + (0 + 0) + (0 + 0)

A visual simulation graphics library overlays the basic graphics library. The visual simulation graphics library is an API for creating real-time, multi-processed three-dimensional visual simulation graphics applications. As will be understood by those skilled in the art, the visual simulation graphics library may include a suite of tools for two-dimensional and/or three-dimensional microseismic data interpretations including, for example, interactive horizon and fault management, three-dimensional visualization and attribute analysis. The visual simulation graphics library therefore, provides functions that bundle together graphics library state control functions such as lighting, materials, texture, and transparency. These functions track state and the creation of display lists that can be rendered later.

This disclosure teaches the use of multilayered computer generated images wherein the color, size, shading and opacity (transparency or translucency) of symbols representing microseismic events can be graphically and interactively changed or manipulated in three dimensions (3D) in order that the characteristics of the subsurface geologic conditions can be readily understood. The microseismic events are sometimes referred to as spheres or dots. It will be appreciated that each blending mode or variable set (depth, certainty, magnitude, etc.) may have its own color scheme. The examples provided in FIGS. 1 through 7, discussed below, are examples only.

FIG. 10 illustrates the blending of the disclosure. Two different colored spheres 121, 123 are depicted on a 2 dimensional plane. The spheres overlap much as spheres representing separate microseismic events overlap in a static view of data. Each color could be represented as values of the set RGB. The zone of the overlap 122 is a combination of the two colors. The color of the overlap is a combination of the RGB values of each sphere. It will be appreciated that both spheres 121, 123 are presented as translucent or transparent objects. If the spheres were displayed in an opaque mode, there would not be a visible overlap.

The data can be displayed in a 3D representation in real time. This means that the display will change as the varied data is received. As stated elsewhere herein, the user will perceive the visual display of data changing instantaneously.

The X, Y and Z orientation of the symbols can also be changed. The function of changing these variables will be in response to a user's direction. The direction may be given through a user interface control display. One embodiment of a control display screen is shown in FIGS. 1 through 7. It will be appreciated that FIGS. 1 through 7 depict screen shots of an actual visual display of one embodiment of the disclosure.

The images created by the disclosure may be viewed real time, i.e., while the hydraulic fracturing occurs and the microseismic data is processed into machine readable numbers. The visual display is generated by the GPU as pixels from data received from the CPU (processed from an event catalog). The event catalog can be stored on a disk as CSV data and inputted into the CPU. Alternatively it may be transmitted by a satellite link. As used in this disclosure, “real-time” means manipulating and presenting the data as it is received by the system. The computer display of this method and system is also interactive, i.e., the display may be refreshed at a rate of 60 Hz or better. Interactive also means that the display or image can be rotated 360 degrees in any direction in 3 dimensions. The image is comprised of pixels.

The system subject of this disclosure receiving the machine readable data comprises a CPU, memory, e.g., random access memory and/or non-volatile memory devices such as RAM (Random Access Memory), a GPU with memory, e.g., Video RAM (VRAM), D.RAM, display memory, a bridge, one or more input devices and a display screen interfacing with a mouse, tracker ball or equivalent. These hardware components may be interconnected according to a variety of configurations and may include one or more GPU's and CPU's. Machine readable means the data can be processed and manipulated by the system subject to the program controls. The data can be in one of several languages, depending in part upon the nature of the data and processing hardware, e.g., C++, .GSLS, CSV, etc.

Non-volatile memory devices may include, for example, devices such as tape drives, semiconductor ROM (Read Only Memory) or EEPROM (Electrically Erasable Programmable Read-Only Memory). Input devices may include, for example, devices such as a keyboard, a mouse, a digitizing pad, a track ball, a touch-sensitive pad and/or a light pen. Display devices may include, for example, devices such as monitors, projectors and/or head-mounted displays. Interface devices may be configured to require digital image data from one or more acquisition devices and/or from one or more remote computers or storage devices through a network. Any variety of acquisition devices may be used depending on the type of object being imaged. The acquisition device(s) may sense various forms of mechanical energy (e.g., acoustic (microseismic) energy, displacement and/or stress/strain).

Each processor (GPU and CPU) may be configured to reprogram instructions and/or data from RAM and/or non-volatile memory devices, and to store computational results into RAM and/or non-volatile memory devices. The program directs each processor to operate on a set of microseismic-data traces and other two-dimensional based on the methods described herein.

The disclosure teaches the use of multilayered imagery and utilizes the techniques of 3D blending. This includes changing the blend mode upon the 3D computer generated image among alpha blending, additive blending, and opacity. In computer graphics, alpha compositing is the process of combining an image with a background to create the appearance of partial or full transparency. Separate images are created and combined (rendered) into a composite image. Opacity is the opposite of transparency (transparent). Opacity can mean that something is partially transparent. Opacity can be adjusted or manipulated by the computer user. As used herein, opaque is defined as entirely non-transparent.

Additive blending is a method that uses an additive color model rather than an opaque model. A computer image consists of pixels, and each pixel has three different color channels, i.e., red, green, and blue, commonly referred to as RGB. Normally, images are rendered opaque, meaning that when an image is drawn to the screen, the old RGB values at the associated pixels are entirely replaced and overwritten by the new RGB values, thereby performing no blending. With additive blending, instead of simply replacing the old pixels with the new pixels, the final pixel is the sum of the two pixels as per the following formula:

Old Pixel=(R1, G1, B1)

New Pixel=(R2, G2, B2)

Final Pixel=(R1+R2, G1+G2, B1+B2)

Additive blending is a method that uses an additive color model. The pixels of the base map and a light map (multiple layers) are blended together to make a brighter texture. In the additive color model, red, green, and blue (RGB) are the primary colors, and mixing them together creates white.

Additive blending is utilized by the system to illustrate multiple layers of microseismic events where, due to the 3D orientation of the visual display perspective, one or more microseismic event is positioned behind another event symbol. This technique allows the viewer to see the multiple events. Additive blending may utilize an additive buffer.

Because additive blending is a summation of RGB values, it can never make the image darker, only brighter, unlike alpha blending. Alpha blending utilizes a hidden 4th color channel per pixel called “alpha”. An Alpha channel is an 8-bit layer in a graphics file format that is used for expressing translucency. The additional eight bits per pixel serve as a mask and represent 256 translucency levels from entirely clear (0) to opaque (255), with levels in between representing the degree of haziness. When using alpha blending, pixels are said to be made up of RGBA values. With alpha blending, instead of simply replacing the old pixels with the new pixels, the final pixel is a blending of the two pixels as per the following formula:

Old Pixel=(R1, G1, B1, A1)

New Pixel=(R2, G2, B2, A2)

Final Pixel=(A2*(R2−R1)+R1, A2*(G2−G1)+G1, A2*(B2−B1)+B1)

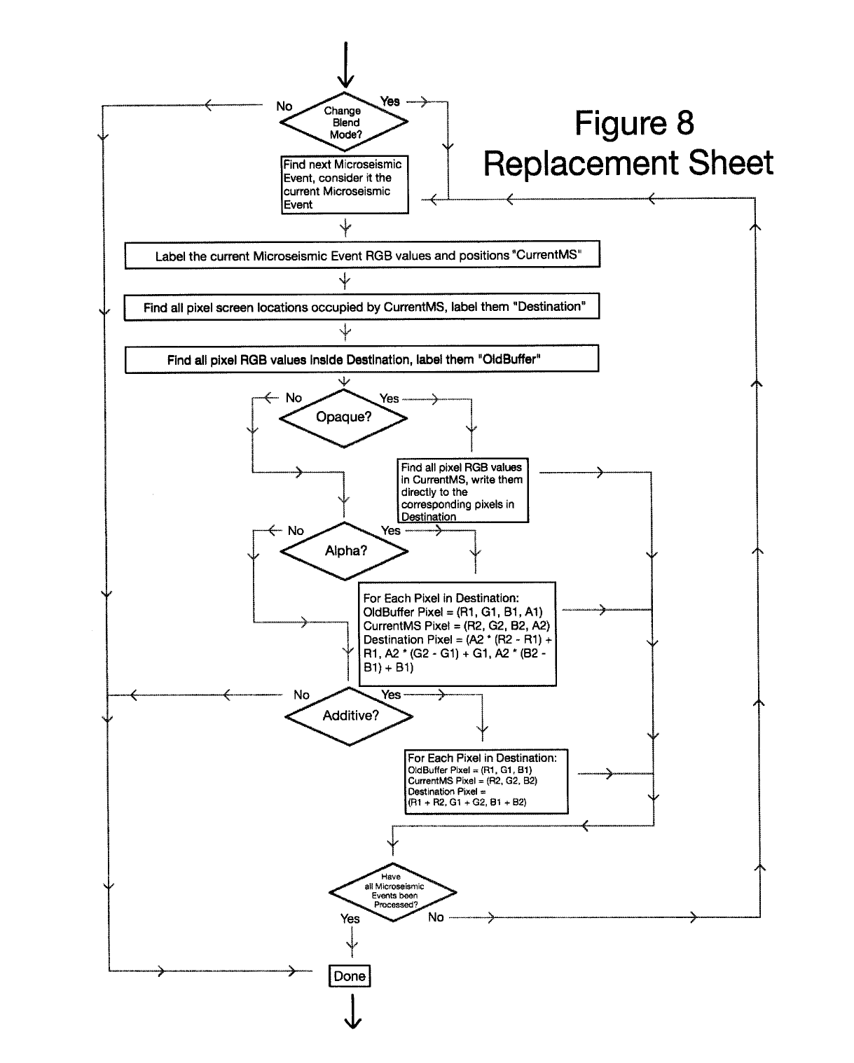

Visually, the result of an alpha blend is always darker than the result of an additive blend. FIG. 8 shows an embodiment of a logic flow diagram utilizing alpha blending.

As stated, the primary colors (red, green and blue) are added together to get white. To get a lighter color more of each color is used, or to get a darker color less of each color is used. Additive is the color model used to display graphics on a computer screen, where all the colors are just combinations of the colors red, green and blue. Alpha blending is used whenever the alpha value is used to modify the RGB values—e.g. anywhere Alpha is used in one of the equations above.

The method of the disclosure will, in one embodiment, utilize a graphics processing unit. The graphics processing unit (GPU) provides a processor and memory and thereby allows the CPU to perform other tasks.

Using the control features illustrated in FIGS. 1-7 briefly described above, it is possible to vary the symbols represented on the 3D visual screen by amplitude, depth, distance to wellbore, stage, or time. It will be appreciated that the control features illustrated in FIGS. 1 through 7 are illustrations of one embodiment only. The disclosure is not limited to the features or orientation of these controls. In addition, other controls and features can be utilized.

Alpha blending can be activated by opening the Style tab of the Microseismic Settings window, locate the Dot Style section and clicking on the button labeled “Focus”. Note alpha blending can also be activated by clicking on the button labeled “Solid”. To activate additive blending, the same functions are performed on the control panel but the user clicks on the button labeled “Hotspot”.

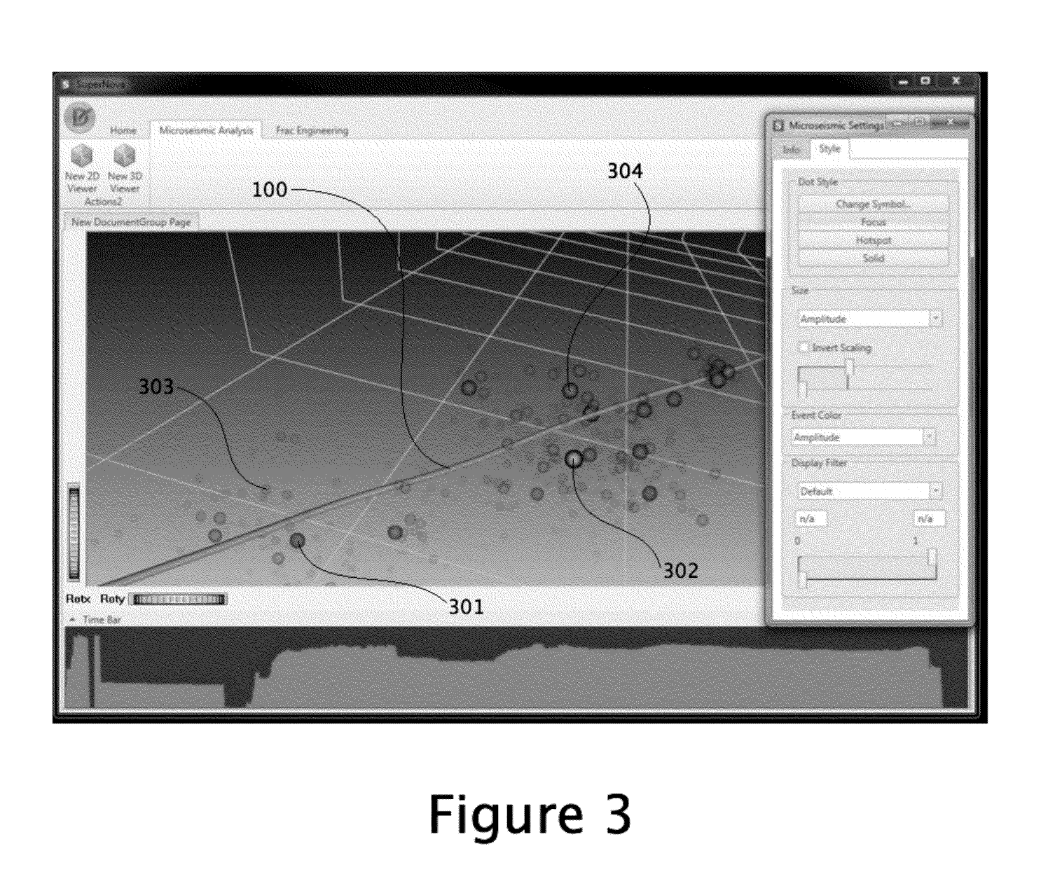

To scale the size of each event by its Amplitude, the user opens the Style tab in the Microseismic Settings window, locates the “Size” button, clicks the combo box to display a list of all potential size variable, and from this list, the user clicks on the element labeled “Amplitude”. For the display shown in FIG. 3, the checkbox labeled “Invert Scaling” is unchecked. In the “Size” section, the user drags the sliders to adjust the minimum and maximum size of the microseismic event symbols to the desired setting.

The size of each event symbol (shown in FIGS. 1-7 as spheres) can also be scaled by the inverse of its amplitude (not shown). The user opens the Style tab in the Microseismic Settings window, in the Size section, clicks the combo box to display a list of all potential size variables, and from this list, clicks on the element labeled “Amplitude”, marks the check box labeled “Invert Scaling and adjusts the Size section to the desired size.

The disclosure also teaches interactive 3D visual displays comprising fully adjustable colors, and varied representations of microseismic events in a 3D space. Each variable (amplitude, depth, distance to wellbore, stage, time) may have its own unique color map. It will be appreciated that the disclosure is not limited to a particular color or color scheme or system.

To set the color of each event based on its Amplitude, the user opens up the Style tab in the Microseismic Settings window, locates the “Event Color” section and click the combo box to display a list of all potential color variables. From this list, select the desired color and click on the element labeled “Amplitude”. As described more completely below, in one embodiment of the invention each variable has its own color sequence or color scheme.

In the embodiment disclosed in FIGS. 1 through 7, the event symbols (spheres) depicting event amplitude are colored from white to blue to red to yellow with yellow be the largest and white the smallest. It will be appreciated that each pixel has a RGB value assign to it. As described in conjunction with FIG. 8, only certain pixel values will be manipulated. When using Stage (designating one or more hydraulic fracturing events along the wellbore), the symbols are colored according to a series of high-contrast alternating colors. Thus each stage will be illustrated in a color in high contrast to the next adjoining stage. When using Depth, the symbols (spheres) are colored from orange to green to blue to violet. Depths high above the wellbore will be orange. An event close to the wellbore depth will be greenish-blue and an event far below the well bore appears violet. When using Distance to Wellbore the symbols are colored from red to yellow to green to blue. When using Time the symbols are colored from black to red to orange to tan to white. It will be appreciated that the specific colors may be changed and the disclosure is not limited to any color or color scheme.

The variables of color, size, shading, opacity can be controlled by a graphics processing unit in response to user inputted criteria. It will be appreciated that the user can vary the selection of illustrated criteria by adjusting the setting on the GPU from a display page, i.e., control display (see, for example, FIG. 1). The settings can include color, size, shading, opacity, amplitude, direction, probability and orientation. The system and associated hardware preferably comprises a graphics processing unit GPU capable of performing the OpenGL 3.2 specification (or higher). OpenGL is managed by the nonprofit technology consortium Khronos Group.

A graphics processing unit GPU will be understood to be a type of video adapter that contains its own processor to boost performance levels. These processors are specialized for computing graphical transformations, so they achieve better results than the CPU used by the computer. In addition, they free up the computer's CPU to execute other commands while the GPU is handling graphics computations. The GPU may have its own memory reserved for storing graphical representations.

In one embodiment, transparency is used to signal uncertainty in the location of the microseismic event. This uncertainty can arise from conflicting data from the plurality of geophones.

The symbols displayed in the visualizations subject of this disclosure will be represented as three dimensional objects. The objects can be shown as superimposed upon one another depending upon the X, Y and Z orientation. This allows improved and faster understanding of the spatial relationship between objects, i.e., microseismic events.

The image will provide a perception of depth. Directionality and orientation of symbols depicting the events in the X, Y and Z axes will be shown. It will be appreciated that directionality of the shear slips of a microseismic event can be very important in evaluating the productivity of a well bore. (At low levels of strain the overall simple shear causes a set of small faults to form.)

It will be appreciated that the 3D image can be displayed from any orientation. Stated differently, the image may be shown from the top (map) view, side view or bottom view. See for example FIGS. 1, 3, and 5. The image can be rotated around any axis interactively. The user will perceive this image interactivity as occurring instantaneously. For example, the image can be viewed interactively along the axis of the wellbore. Further, the display can show only a selected portion of the length of the wellbore. All of these variables can be utilized in real time by manipulation of computer function keys a computer mouse, or a touch driven interface. Each microseismic event symbol will maintain its proper orientation vis-à-vis the depicted wellbore and the other event symbols. Maintaining this proper orientation occurs during rotation of the image and focusing in (expanding the image) or focusing out (reducing the image).

In one embodiment pertaining to the orientation of the X, Y and Z axes, each microseismic event symbol becomes a discrete value. The color or shading of the symbol will not blend with symbols that may be repositioned behind the symbol. Only the symbols in front of the view will be shown. The remaining symbols will be hidden in the background. This is termed hereinafter as “opaque mode”.

Turning now to the drawings, FIG. 1 depicts the control screen for the display. Also shown are the microseismic events recorded for a plurality of geologic stimulations. FIG. 1 shows all the events and the position of the events. Each microseismic event is depicted. It is readily apparent that the many of the event symbols are obscured by the events closest to the perspective of FIG. 1. Examples of microseismic events are shown 121, 122. Also shown is the wellbore 100. This view does not supply information regarding the location of all events. It also does not supply information regarding the amplitude or size of the microseismic event. It will be appreciated that the control settings are set on the opaque mode. It will be appreciated that the adjustment or resetting of the control function is instantly reflected in the visual display.

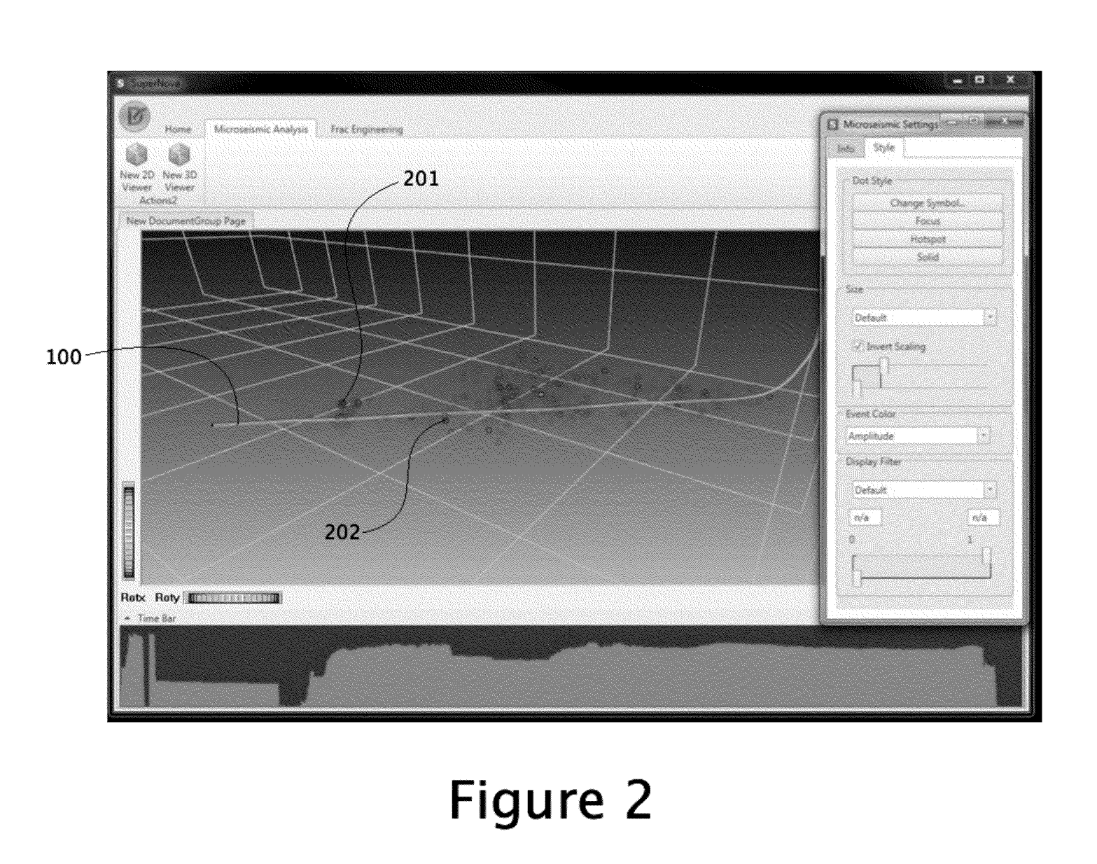

FIG. 2 illustrates the same data from the same display perspective but with alpha blending active. The wellbore 100 is now clearly visible in FIG. 2. Note that FIG. 1 shows all microseismic events and their positions. Many of the events are obscured by the top layer of event symbols. FIG. 2, utilizing alpha blending, eliminates approximately 90% of the events. Clearly illustrated events 201, 202 occurred in relative isolation and therefore have not be diminished by Alpha blending. Alpha blending is another visualization tool that can be used to filter out selected data. It allows the user to focus upon data or events of interest with background clutter removed. For example, alpha blending could be combined with selection of events within 50 feet of the wellbore. All events occurring greater than 50 feet would be removed and alpha blending applied to the remainder. Again the incidences of translucency of events would signify multiple proximate events. The display could be rotated and the events could be viewed from the bottom looking up through the geographic formation. From this differing perspective, the order of events relative to the point of observation or point of perspective would be different. For example it may be possible to see a large event that occurred below the wellbore. This event was obscured when viewed from the top. In yet another example the control settings could be adjusted to also highlight the magnitude of each event. This would provide further clarity to the depiction of events. Events that were obscured by other proximate events would now be enlarged. It will be appreciated that the user can instantly change modes of perspective and display. This will instantly allow the user to verify and repeat visual impressions from the variously displayed data. This is an example only and the user may find it more enlightening to vary the display by color, time, stage or event distance to or from the wellbore. It will be appreciated that the change in displays from FIG. 1 to FIG. 2 is perceived by the user to occur instantly.

FIG. 3 depicts the same microseismic events (also depicted in FIG. 2) but provides a visual depiction with scaled symbols (again spheres) with alpha blending active. The wellbore 100 is again illustrated. As mentioned the spheres 301, 302, 304 are scaled based upon the amplitude of the events.

Contrast events 303 of lesser magnitude. Notice that the user can quickly and easily identify all the events with the largest amplitudes, and they can also intuitively compare the amplitudes at a glance. The borehole 100 is also depicted.

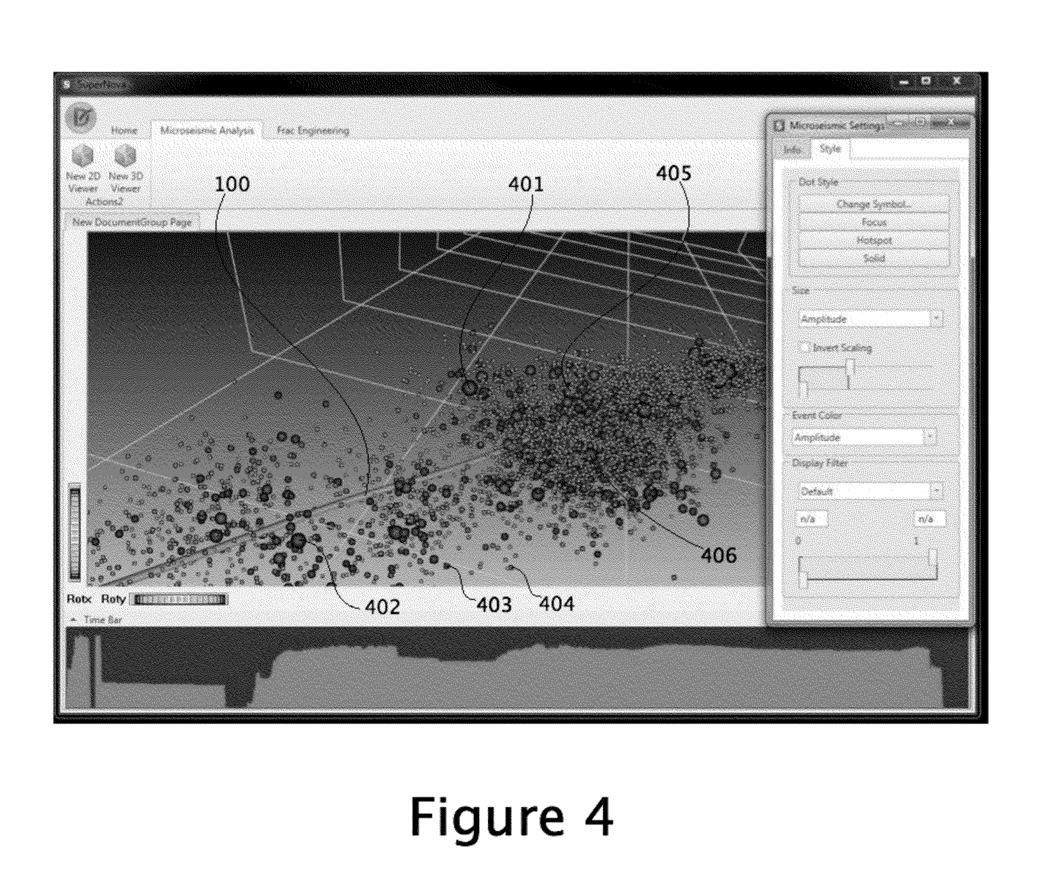

The exact same data displayed in FIG. 3 is displayed in FIG. 4. The perspective views are identical. FIG. 4, however, uses additive color blending with transparency. The locations of more microseismic events are displayed 403, 404. Also displayed are locations for high amplitude events 401, 402. The borehole 100 is again displayed. However with the bending active, more event symbols (spheres) are shown. This makes it more difficult to see the high amplitude events in FIG. 4. Contrast this view in FIG. 3, 302, 304, with FIG. 4, 405, 406. Isolated events 402, 403, 404 are visible regardless of amplitude. In areas with a large number of small-amplitude microseismic events, it is nearly impossible to see the larger, more important events. It is now also much harder to compare the largest events to each other at a glance.

The functional distinctions among the alpha- and color-blending are demonstrated between FIGS. 3 and 4.

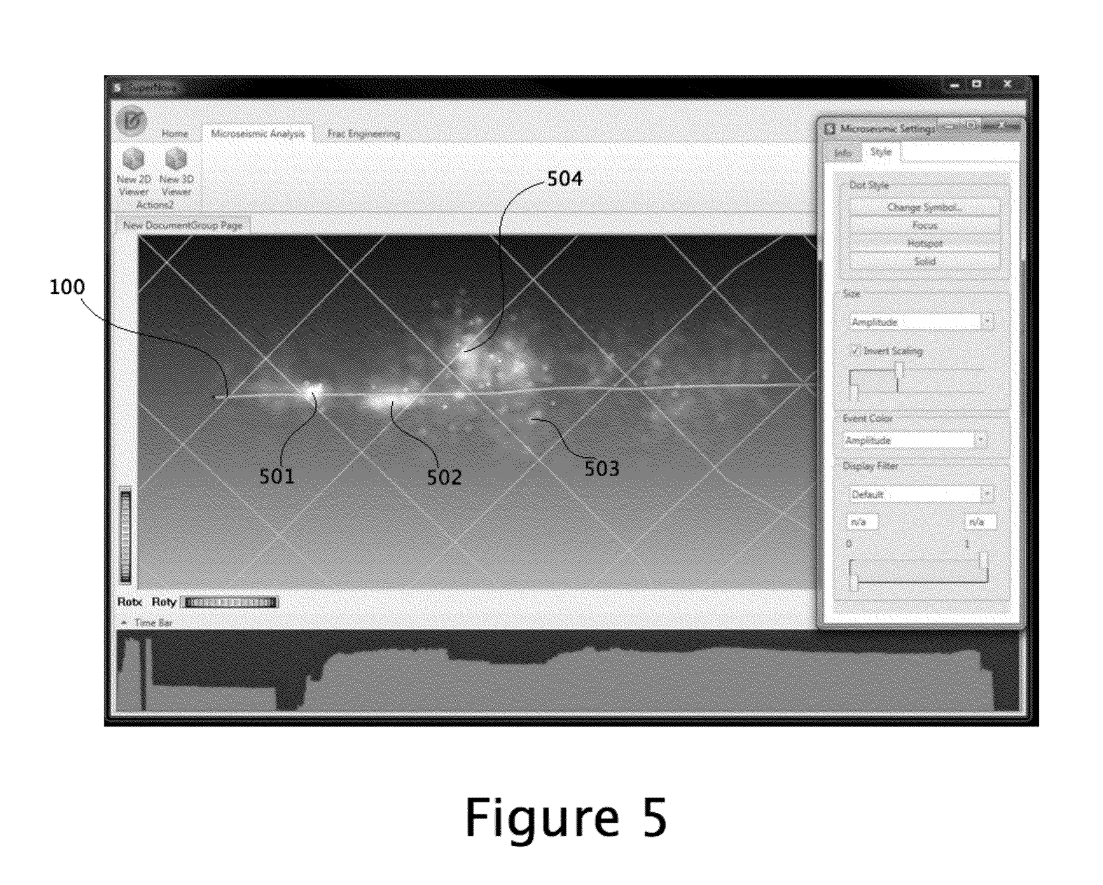

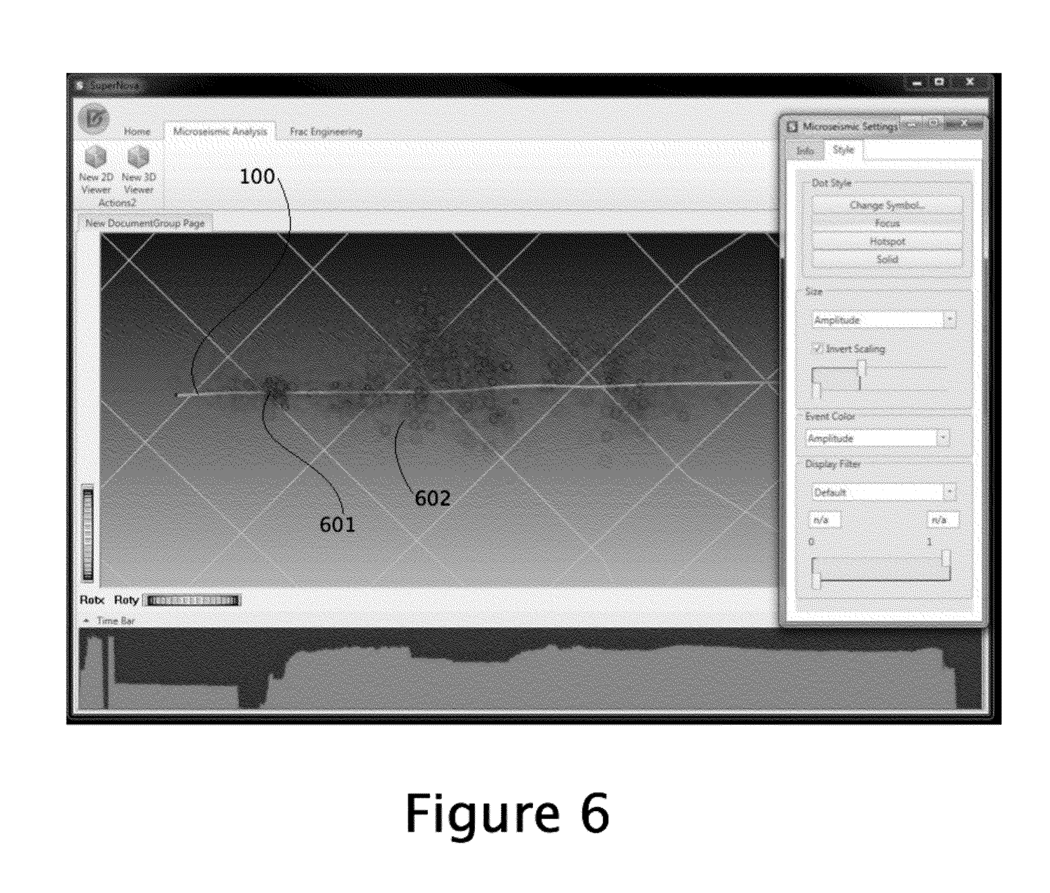

FIGS. 5, 6 and 7 depict the identical data in three different formats. The listed Figures all view the geographic formation from the top (looking down into the formation). In FIGS. 5 and 6 the wellbore 100 is clearly visible. If the user wants to see the regions with the highest intensity 501, 502, 504 of microseismic activity, i.e., greatest number of events within a given area, then the user would set the Color variable and the Size variable to “Amplitude”, the Invert Scaling attribute to true, and the blend mode to Additive Blending. Note the area of lesser event intensity 503. The product is seen in FIG. 5 where the additive function causes the view to white out in area of high intensity. This is because there are a high number of pixels from the numerous events positioned in this location.

Notice that the user can easily recognize the area around the wellbore with the highest amount of microseismic activity 504, and they can also clearly see the location of the most intense microseismic events 501, 502 inside the affected region. It will be appreciated that events closest to the wellbore can be anticipated to most greatly affect the wellbore production. When the same scene FIG. 6 is set to Alpha Blending, one region 602 of high activity is darkened and obscured, making it harder to gauge the total microseismic activity in the area and see the most intense events therein. Event region 601 remains visible.

Again, this is graphic demonstration that the multiple display methods of the disclosure provide the best, most complete view of the microseismic response to hydraulic fracturing. The microseismicity can be viewed in multiple modes and different features can appear or be confirmed by this combined methodology.

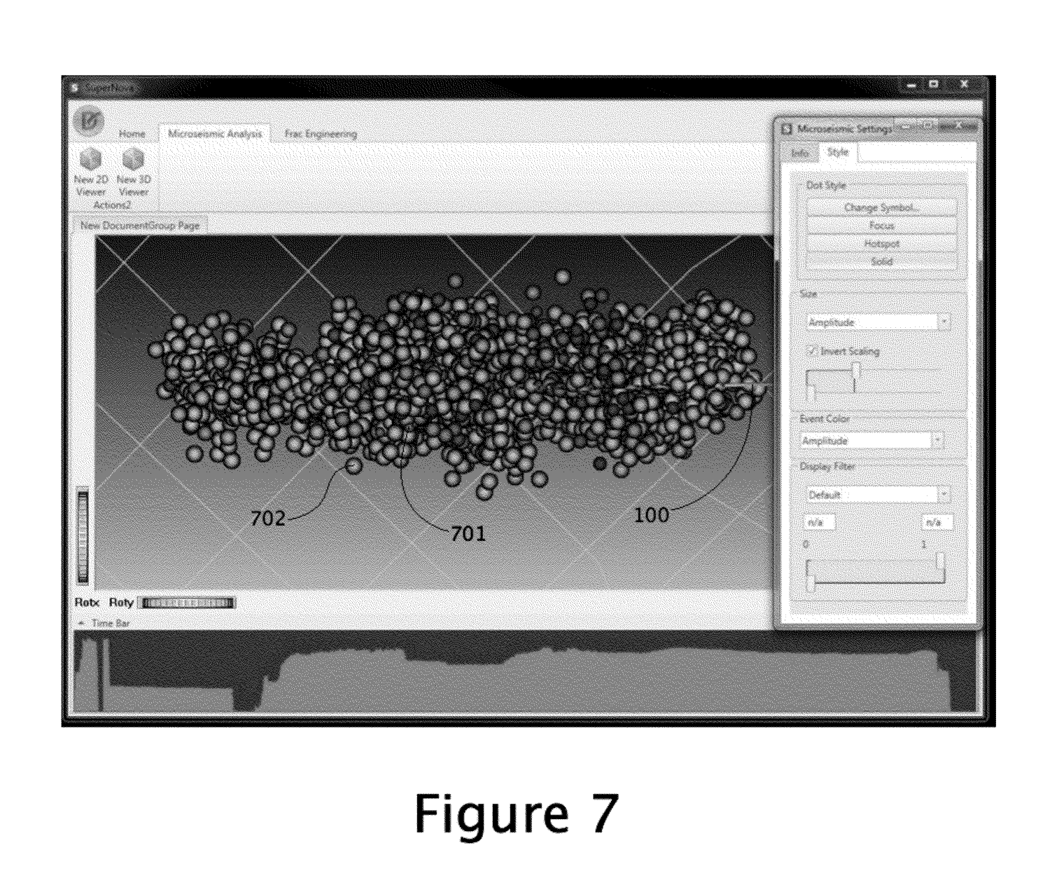

FIG. 7 again shows the same view with the same settings but with opaque mode active. Note that the user is unable to see into the cluster of microseismic events. Note further that the events 701, 702 are scaled in color by amplitude. The wellbore 100 is again visible.

It will be appreciated that the viewing perspective (display perspective) can be adjusted a full 360 degrees. This means the data depicted in a 3D space can be viewed at any angle or perspective. The display can be rotated a full 360 degrees. This will be perceived by the user as occurring instantaneously, i.e., interactively. As mentioned, the data symbols will maintain their orientation to the other data points during this rotation and may become obscured to the user during the rotational movement. This is an additional feature of the method subject of this disclosure.

The display perspective of the event depicted in FIGS. 5, 6, 7 is different than presented in FIGS. 1 and 2. In both cases the same event or data is depicted. The method of display is different. The symbols are shown as 3D objects (spheres). The size of the symbols varies. Compare symbol 701 with symbol 702. The view of the borehole 100 is obscured in FIGS. 1 and 7. It will again be appreciated that the control settings in FIGS. 1 and 7 are opaque. FIG. 7 makes approximately 90% of microseismic events invisible, i.e., they are hidden behind the opaque surface of top microseismic events, making it much harder to get an overall picture of where the events are taking place.

The method taught by this disclosure can be used to display this same data in different manners. FIGS. 1 through 7 are examples only and are not limitations. For example, a computer generated display may include a depiction of a wellbore. See FIG. 1. The user can select a view showing only microseismic events occurring within fifty (50) feet of the wellbore. The user will make this selection using the user interface control display. All of the symbols for events greater than fifty (50) feet from the well bore will not be displayed.

In another example, (not shown) the degree of certainty of a microseismic event can be depicted by varying the opacity of the event symbol. An event with great certainty can be represented by an opaque symbol. An event having an uncertain event location will be translucent. The degree of translucency may vary with the degree of uncertainty. (Uncertainty of an event location may occur as the result of conflicting data from the multiple geophones.) In yet another example the symbols can be illustrated by signal amplitude. The larger the graphic depiction of the symbol, the larger the recorded signal amplitude. In another variation, only signals having a selected threshold amplitude can be displayed.

Turning to FIG. 8, the user is given the option 101 to change the blend mode of the event symbols. Note the event symbols are the dots or spheres depicted in FIGS. 1 through 7. If the blend mode is to be changed 102, the user instructs the system to find the next microseismic event and consider it the current microseismic event. Next 103, the instruction is given to label the current microseismic event RGB values and positions as “currentMS”. The next step 104 is to find all pixel screen location occupied by currentMS and label them “destination”. The next step 105 is to find all pixel values outside destination and label these values “oldbuffer”. If the opaque mode 106 is selected, find all pixel RGB values in currentMS, write them directly to the corresponding pixels in destination 107. If Alpha blending is selected 108, utilize equation of [0042 ] to [0044 ] with the final values marked destination pixel 109. If additive mode is selected 110, select for each pixel destination, oldbuffer pixel=(R1, G1, B1) and currentMS pixel=(R2, G2, B2) with the destination pixel value (R1+R2, G1+G2, B1+B2) 111. The system queries whether all microseismic events have been processed 112.

This specification is to be construed as illustrative only and is for the purpose of teaching those skilled in the art the manner of carrying out the disclosure. It is to be understood that the forms of the disclosure herein shown and described are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the disclosure maybe utilized independently of the use of other features, all as would be apparent to one skilled in the art after having the benefit of this description of the disclosure.

While specific embodiments have been illustrated and described, numerous modifications are possible without departing from the spirit of the disclosure, and the scope of protection is only limited by the scope of the accompanying claims.

1. An interactive 3 dimensional microseismic event color visual display method comprising the steps of:
a) Conducting at least one hydraulic fracturing proceedure with placement of geophones;
b) Integrating and correlating data received from the geophones responding to a originating miscroseismic event;
c) Creating an event catalog comprising an integrated and correlated data of selected variables for each microscopic event;
d) Inputting data from the event catalog of microscopic evnets into a CPU wherein the CPU has a specialized capability to calculate 3 dimensional coordinates combined with the selected variables into selected shapes of one or more microseismic events received from the event catalog;
e) The CPU assigning values received from the event catalog using a three or four variable set to all 3 dimensional microscopic event data of each shape wherein at least one variable is color;
f) inputting the converted data from the CPU to a graphic processing unit;
g) The CPU performing three dimensional alpha- and color-blending; and
h) converting by the GPU the converted microscopic event data to a format allowing the data to be presented as a three dimensional visual display.

2. The method of claim 1 further comprising controls adapted to maneuver the three dimensional visual display 360 degrees on a two dimensional visual display screen.

3. The method of claim 1 further comprising changing the orientation of the visual display on the visual display screen by manipulating a 3 dimensional data variable of converted microseismic events.

4. The method of claim 1 further comprising using the GPU imputed and converted data base for changing assigned values of the variable set for one or more microseismic events.

5. The method of claim 1 comprising using the GPU to include an alpha variable in each variable set.

6. The method of claim 1 comprising assigning color values to three variables to the variable sets wherein the colors are red, green and blue.

7. The method of claim 4 comprising assigning a value to the alpha variable based upon factors comprising one or more of the following: time, probability, magnitude, location, proximity to a borehole, depth, degree of certainty, directionality of the shear slips, intensity, amplitude or combinations thereof.

8. A computer-implemented data processing method comprising:
a) uploading a 3 dimensional microseismic event data set;
b) selecting a display perspective;
c) selecting a 3 dimensional microseismic event display utilizing color or shape from the variables of amplitude, location, depth, probability, direction, time, distance from wellbore and combinations thereof; and
d) modifying the microscopic event display by additive blending, alpha blending or opacity or variations thereof.

9. The method of claim 8 further comprising characteristics of the display of each event data as a translucent symbol or opaque symbol.

10. A method for 3 dimensional color display of a microseismic response to geologic stimulation comprising a microseismic response is displayed correlated to amplitude, location, depth, probability, direction, time, distance from the wellbore or combinations thereof.

11. The method of claim 3 further comprising utilizing additive blending to display the microseismic response.

12. The method of claim 3 further comprising utilizing alpha blending to display the microseismic response.

13. A 3 dimensional microseismic event color visual display system comprising:
a) a database containing microseismic event data;
b) a CPU or microprocessor including components to accept the data and assign 3D positions to each event data in real time;
c) a bridge conveying event data from the CPU or microprocessor to a GPU;
d) the GPU configured to assign one of more colors to each event data in response to control settings and to rotate the visual display in response to controls:
e) a display module.

14. The system of claim 13 further comprising the GPU to assign values to each event data for display in additive mode, alpha mode or opacity or opaque mode.

15. The system of claim 13 further comprising controls adapted to manipulate the display of event data by parameters of magnitude, intensity, probability, direction, time position, microseismic event, direction of shear shifts or combinations thereof.
